(19) United States
(12) Patent Application Publication
(10) Pub. No.: US 2007/0247971 A1
(43) Pub. Date: Oct. 25, 2007

(54) Four dimensional seismic survey system and method

(76) Inventors: Ole-Fredrik Semb, Borgheim (NO); Kenneth Karlsen, Oslo (NO)

Correspondence Address: E. Eugene Thigpen;Petroleum Geo-Services, Inc., P.O. Box 42805, Houston, TX, 77242-2805, US

(21) Appl. No.: 11/407,656

(22) Filed: Apr. 20, 2006

(51) Int. Cl. G01V 1/38

(52) U.S. Cl. 367/15

(57) ABSTRACT

In one embodiment the invention comprises a method for performing a repeated marine seismic survey which includes towing at least one seismic source behind a seismic survey vessel substantially along the path of a previously conducted seismic survey, determining the position of the at least one seismic source during the repeated marine seismic survey and comparing the determined position of the at least one seismic source with a position of a seismic source during a previously conducted seismic survey. The position of the at least one seismic source is adjusted in response to said comparison.

### CROSS-REFERENCES TO RELATED APPLICATIONS

Not applicable

### STATEMENT REGARDING FEDERALLY SPONSORED RESEARCH OR DEVELOPMENT

Not applicable

### BACKGROUND OF THE INVENTION

In performing marine seismic surveys, typically, a seismic survey vessel tows a plurality of streamer cables and a plurality of source arrays behind the vessel. The seismic source arrays, typically comprising a plurality of individual air guns, generate an acoustic signal upon command from a command and recording system, normally onboard the seismic survey vessel. The acoustic signals travel downwardly into the Earth's subsurface, and are reflected from the interfaces between subsurface strata having different acoustic impedances. The reflected signals are then detected by receivers, typically hydrophones, deployed in the plurality of streamer cables, and the detected signals are recorded by the command and recording system. Images of the subsurface are then generated from the detected and recorded seismic data, and these images are evaluated to predict regions that are favorable for the accumulation of petroleum.

The towed streamer cables are towed along a chosen path to perform the survey in a chosen area. The movement of the vessel and the towed streamer cables is controlled to secure coverage of the desired areas. Seismic surveys which utilize a plurality of streamers laterally deployed behind the survey vessel are typically referred to as 3D (three dimensional) surveys. Recently, there has been an increased interest in 4D (four dimensional) surveys, in which seismic data are gather in an initial 3D survey, and the survey is then repeated at later times to determine changes in the subsurface that may have occurred with time. Especially, if petroleum is being produced from a reservoir, successively performed seismic surveys can provide an indication of fluid (either petroleum or brine) displacement in the reservoir as the reservoir is being produced. In the successively performed surveys it is important that the position of the streamer cables and the source arrays duplicate the positions of the streamer cables and source arrays from the previously performed surveys.

It is known to the prior art to control the locations of the streamers during the subsequent surveys in order to duplicate the streamer locations from the initial survey. However, the accuracy of the comparison of data recorded during subsequent surveys with the data from previous surveys may be reduced if the seismic source locations differ between earlier and later surveys.

### SUMMARY OF THE INVENTION

In one embodiment the invention comprises a method for performing a repeated marine seismic survey which includes towing at least one seismic source behind a seismic survey vessel substantially along the path of a previously conducted seismic survey, determining the position of the at least one seismic source during the repeated marine seismic survey and comparing the determined position of the at least one seismic source with a position of a seismic source during a previously conducted seismic survey. The position of the at least one seismic source is adjusted in response to said comparison.

In another embodiment the invention comprises apparatus for performing a repeated marine seismic survey which includes at least one seismic source being towed behind a seismic survey vessel during said repeated seismic survey, and means for determining the position of the at least one seismic source during the repeated marine seismic survey. Means are included for comparing the determined position of the at least one seismic source with a position of a seismic source during a previously conducted seismic survey; and for adjusting the position of the at least one seismic source in response to said comparison.

### BRIEF DESCRIPTION OF THE DRAWINGS

FIG. 1 shows a system for conducting a seismic survey in accordance with the present invention.

FIG. 2 shows in more detail a portion of the system of FIG. 1.

FIGS. 2A and 2B show portions of subarrays of seismic energy sources.

FIG. 3 shows an example of a deflector control assembly.

FIG. 4 shows a schematic diagram of master controller.

FIG. 5 shows one example of control panels that may be utilized in the invention.

### DESCRIPTION OF THE PREFERRED EMBODIMENT

The present invention enables repeatable, four-dimensional (4D) seismic data acquisition. The invention utilizes stored tracking data from an initial seismic data acquisition survey. Seismic data acquisition runs performed subsequently endeavor to generate acoustic signals and to detect the resulting signals with seismic sources (or source arrays) and streamer cables positioned at the same locations on the Earth's surface where the signals were generated and detected during the initial seismic survey.

During the initial survey, the position of each source array, relative Earth coordinates, where each seismic signal is generated, is tracked and stored. This stored data may be referred to herein as archive data.

When the initial seismic survey is conducted, which serves as the base survey for a 4D seismic survey operation, a Global Positioning System (GPS) receiver system is typically employed for continuously monitoring the precise geographical position of the seismic survey vessel, the seismic source arrays and the seismic streamers. In addition to the GPS receivers, typically mounted on the vessel, on the seismic source arrays, and at each end of the streamers, position detection systems of a type known to the art, such as acoustic detection systems and compasses, may also be employed. Algorithms known to those of ordinary skill in the art may utilize both the GPS position data and the acoustic data and/or compass data for calculating the precise geographic position of the seismic sources and the streamer cables.

In accordance with the present invention, there is provided, during subsequently performed surveys, a system for controlling the position of the sources so that the seismic signals are generated during subsequently performed surveys in substantially the same locations relative Earth coordinates as during the initial survey.

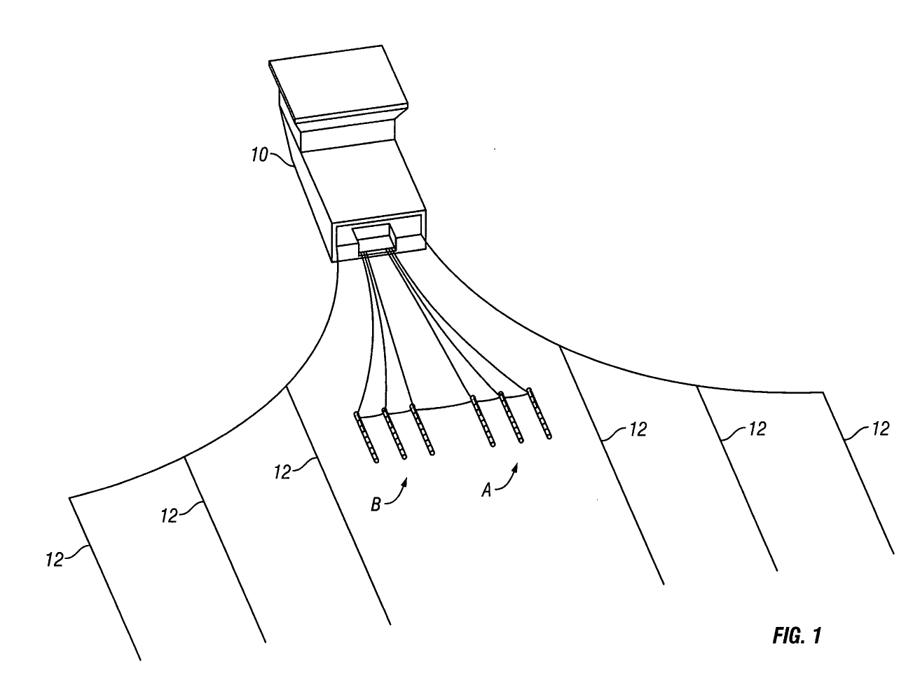

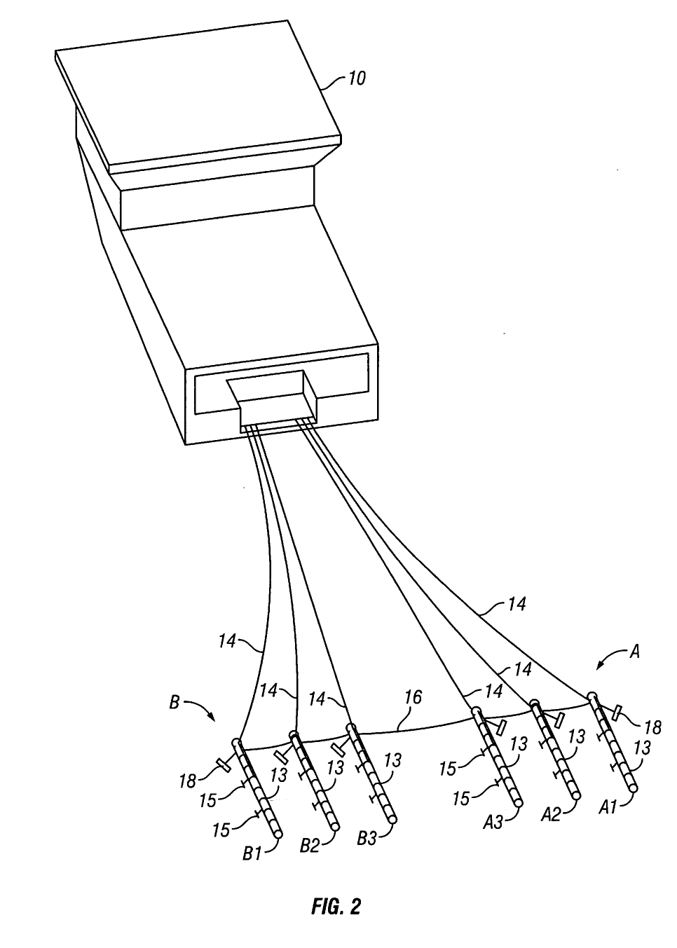

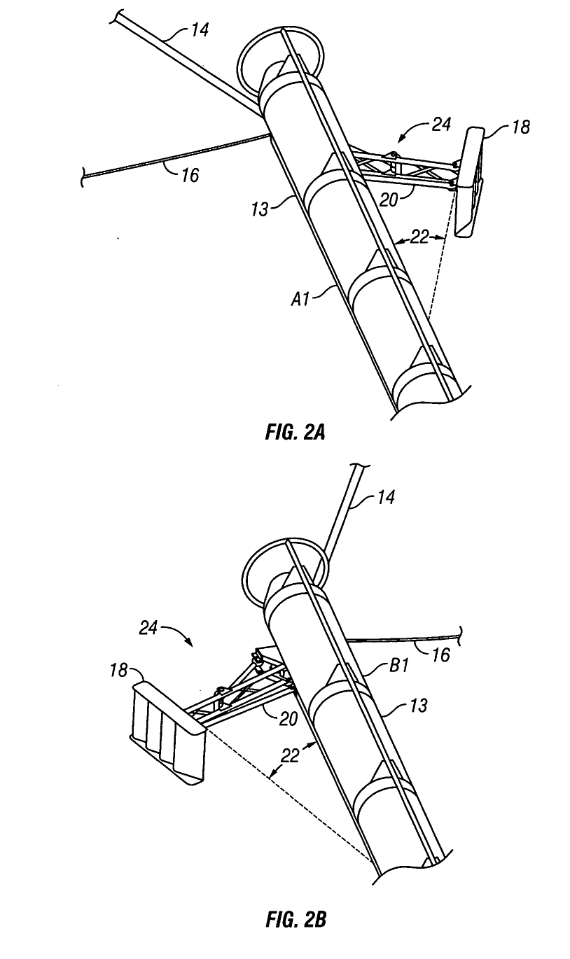

FIG. 1 shows a system for conducting a seismic survey in accordance with the present invention. A seismic survey vessel 10 is shown towing a plurality of seismic streamers 12 and two seismic source arrays A and B. FIG. 2 shows in more detail a portion of the system of FIG. 1. In FIG. 2 the streamer cables have been omitted for clarity. FIG. 2 shows two seismic source arrays A and B, with each source array comprising three subarrays A1, A2, A3 and B1, B2, B3, respectively. It is understood, however, that the invention is not limited to the number of source arrays, or the number of subarrays utilized for practicing the invention. Each subarray is shown towed by the seismic vessel by a cable 14. A spreader line 16 is tied to the front end (the end closest to the vessel 10) of each of the subarrays and assists in maintaining lateral spacing therebetween. The separation between the centerlines of arrays A and B may typically be about 35 meters, and the spacing between the subarrays of an array may typically be about 12.5 meters.

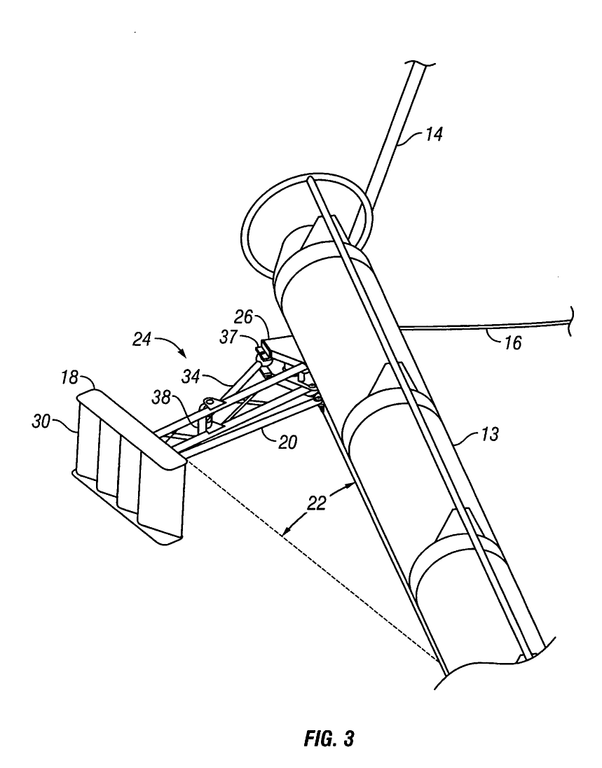

In each subarray, seismic sources 15, typically air guns, are suspended beneath a float 13. Portions of subarrays A1 and B1 are shown in more detail in FIGS. 2A and 2B, respectively. In a particular implementation of the invention, a deflector 18 is connected to the keel (bottom) of a buoy (float) 13 supporting each subarray. However, in other embodiments, the invention may be performed with a deflector connected to less than all of the subarrays, for example, the invention may be implemented with a deflector connected only to the outermost of the subarrays within an array, such as, for example, subarrays A1 and B1. To enable the deflectors to control the position of the source arrays, the deflectors are controllable so as to provide a variable angle between the deflector 18 and the longitudinal body of the float 13. This angle, illustrated as angle 22 in FIGS. 2A, 2B and 3, may be referred to herein as an “angle of attack”.

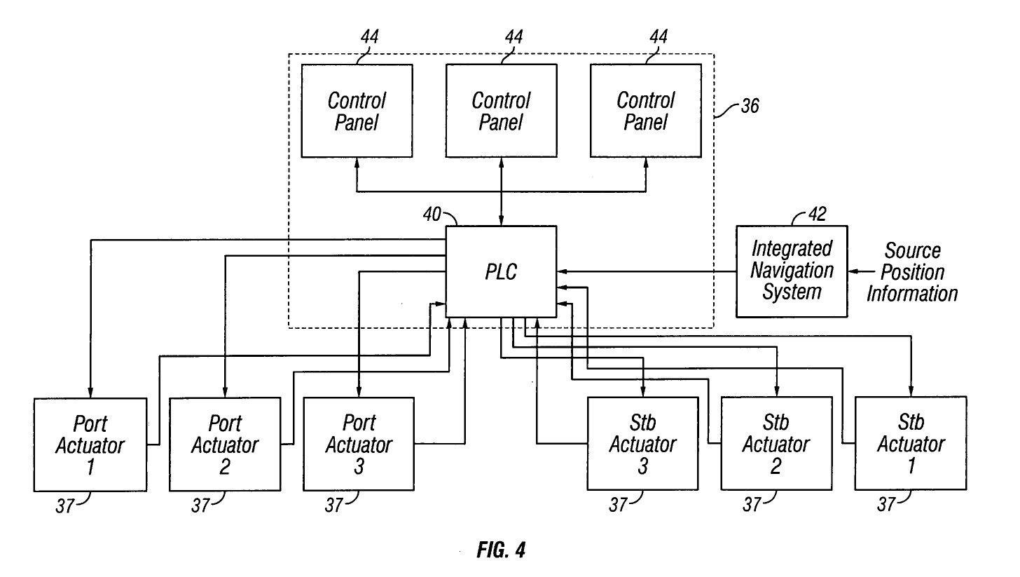

A deflector 18 is affixed to the keel (bottom) of a buoy 13 by a deflector control assembly 24 that enables the angle 22 between deflector 18 and the buoy 13 to be varied. One example of a deflector control assembly is shown more clearly in FIG. 3, which shows the assembly of FIG. 2B in more detail. As shown in FIG. 3 a mounting bracket 26 is fixedly connected to the keel of buoy 13. A deflector 18 comprising a plurality of vanes 30 is coupled to the mounting bracket 26 by means of deflector arm 20 and actuator arm 34. Actuator arm 34 is rotatably connected to mounting bracket 26 to enable the angle 22 between the deflector 18 and the longitudinal axis of the buoy 13 to be varied. This angle variation is controlled by actuator arm 34. In one embodiment, actuator arm 34 comprises a hydraulic mechanism whose extension is controlled by a signal from master control system 36. (See FIG. 4.) Actuator arm 34 is rotatably coupled at one end to mounting bracket 26, and the other end is rotatably coupled to connector rod 38 which is affixed in sliding engagement with deflector arm 20. Thus, by controlling the length of actuator arm 34, the angle of attack 22 is controlled in response to a control signal from master control system 36.

In a preferred embodiment, actuator arm 34 comprises a piston-cylinder assembly whose length is controlled in response to a signal from master control system 36. Actuator arm 34 may be pressure compensated, so that the response of the actuator arm to the signal from the master control system 36 is substantially independent of depth below the water surface over the depth range at which it is anticipated the actuator arm 34 will need to operate.

In a preferred embodiment of the invention, the deflector control system comprises a master control system 36, normally located on the seismic survey vessel and an actuator 37 (not shown in detail) built into the deflector control assembly 24. With reference to FIG. 4, master control system 36 comprises PLC (programmable logic controller) 40, which receives input data from Integrated Navigation System 42 and from one or more control panels (which may be touch screens) 44, and information from the actuators 37 providing the attack angle 22, and generates control information for each of the actuators 37. Input data from the Integrated Navigation System 42 include position deviation/error information derived from source position information and archive data. The functions of programmable logic controllers are well known to those of ordinary skill in the art and will not be described in detail herein.

The invention may be performed in either a manual or an automatic mode. In a particular implementation of the invention, a capability may be included for switching between manual and automatic modes.

Archive data providing locations relative Earth coordinates where seismic signals were generated during an initial seismic data acquisition survey may be stored in the Integrated Navigation System 42. Global Positioning System (GPS) receivers mounted on the seismic source arrays may be utilized to determine the position of the seismic source arrays during the repeated (current) survey. GPS data may also be combined with data from other position detection systems, such as an acoustic sensor system, to improve the accuracy of source position determination. Source positioning data for a seismic source array is transmitted to the Integrated Navigation System onboard survey vessel 10, typically through electrical or optical conductors in cables 14 or through an electromagnetic transmission link. The Integrated Navigation System then calculates the seismic source position and determines the difference between the desired position of a seismic source array (the position during the initial survey) and the actual position of a seismic source array.

When operating in automatic mode, the Integrated Navigation System transmits a control signal for correcting the position of the seismic source arrays to the PLC 40. Control signals for controlling each of the deflectors 18, and hence the position of the seismic source arrays, are generated by the PLC 40 (in response to a signal from Integrated Navigation System 42) and transmitted to the actuators 37. The actuators 37 may comprise an electrical motor and a gear system that controls the extension of actuator arm 34, thereby controlling the angle of attack 22 of the deflector 18. A position sensor externally mounted on the actuator monitors the angle of attack 22, which information is transmitted to the PLC 40. In a particular implementation of the invention the master control system 36 controls the deflectors 18 by transmitting to the actuator 37 a signal for the actuator to begin the movement of the deflector 18, and whether the angle of attack 22 should be increased or decreased. The actuator 37 then varies the length of actuator arm 34 in order to vary the angle of attack of deflector 18. Navigation data used to determine the actual location of the seismic source arrays (or subarrays) relative Earth coordinates is transmitted continuously back to the Integrated Navigation System 42, as described above. The INS 42 calculates the difference between the desired position of the source arrays and the actual position of the source arrays. A signal representing this difference is then transmitted to the PLC 40 within master control system 36. The master control system then calculates the individual deflector angles to minimize the position difference and maintain source separation. These data and control signals transmitted to and from master control system 36 may be transmitted via electrical or optical conductors included in cables 14, or they may be transmitted by an electromagnetic signal utilizing techniques known to those of ordinary skill in the art.

By properly regulating the angle of attack 22 the source arrays may be displaced either to the starboard or port side of the vessel, thereby controlling the position of the arrays.

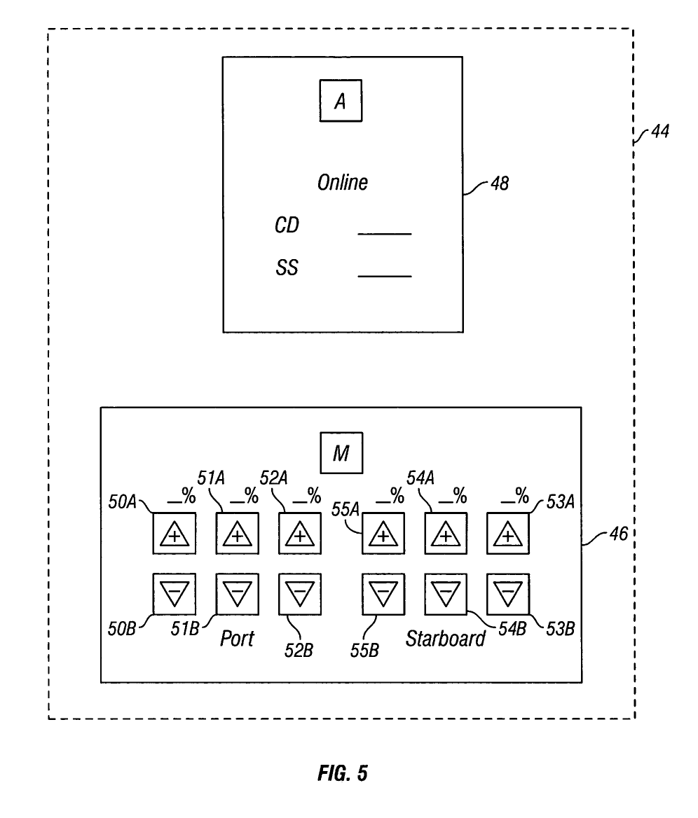

FIG. 5 shows one example of control panels that may be utilized in the invention, including automatic control panel 48 and manual control panel 46. In various implementations of the invention a plurality of duplicate control panels, as indicated in FIG. 4, may be positioned at different locations on the survey vessel to facilitate operations; however, the invention will be described with reference to a single manual and automatic control panel.

In a particular implementation of the invention, the crossline deviation (CD) and the source separation (SS) may be displayed on the automatic control panel 48. These parameters are continuously calculated by the Integrated Navigation System 42 and automatic control panel 48 is updated at frequent intervals, such as, for example, every 50 milliseconds. The crossline deviation (CD) is the lateral difference between the actual path of the seismic source arrays and the desired path, and the source separation (SS) may be the actual distance between the center points of the two source arrays or the difference between the desired separation between the two source arrays and the actual separation. These displays enable an operator to monitor the operations of the system to verify the system operation quality.

At the discretion of an operator the system may be switched from automatic to manual mode. In a particular implementation of the invention, a control panel 44, which may be a touch screen, such as shown in FIG. 5, is utilized to reconfigure the operation of PLC 40 from automatic to manual mode by touching an appropriate control display, such as the location labeled M. Once the system is switched to manual mode, each of the deflectors 18 are operated manually, with the operator selecting the attack angle 22 for each deflector. On manual control panel 46 there is shown control buttons for varying the attack angle 22 for each of three subarrays comprising the port side source array and for controlling each of three subarrays comprising the starboard source array, respectively. Control buttons 50A and 50B increment or decrement, respectively, the attack angle 22 for the outermost subarray A1, of source array A. Control buttons 51A and 51B increment or decrement, respectively, the attack angle 22 for the center subarray A₂ of source array A, and control buttons 52A and 52B increment or decrement, respectively, the attack angle of the innermost subarray A₃ of source array A. Further control buttons 53A and 53B increment or decrement, respectively, the attack angle 22 for the outermost subarray B₁ of source array B. Control buttons 54A and 54B increment of decrement, respectively, the attack angle 22 for the center subarray B₂ of source array B, and control buttons 55A and 55B increment or decrement, respectively, the attack angle 22 of the innermost subarray B₃ of source array B. Above the control buttons for each of the source subarrays is an indicator of current attack angle for the particular subarray. Pressing a particular control button may increment or decrement the attack angle by a selected amount, for example one percent. Automatic control panel 48 will continue to display an indication of crossline deviation (CD) and source separation (SS) while the deflector control system is operating in manual mode, to aid an operator in controlling the source array positions.

In a preferred embodiment, the present invention provides for control of the crossline separation. Arrays A and B may both be shifted to one side or the other of the vessel while keeping the separation of the two arrays constant. Arrays A and B may also be shifted independently of each other to vary the crossline separation. Further, in a particular implementation of the invention the attack angle of all of the actuators may be reduced to essentially zero degrees, to facilitate retrieval of the source arrays onto the survey vessel.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for performing a repeated marine seismic survey comprising:
towing at least one seismic source behind a seismic survey vessel substantially along the path of a previously conducted seismic survey;
determining the position of the at least one seismic source during the repeated marine seismic survey;
comparing the determined position of the at least one seismic source with a position of a seismic source during a previously conducted seismic survey; and
adjusting the position of the at least one seismic source in response to said comparison.

2. The method of claim 1 wherein a GPS receiver mounted on said at least one seismic source array is utilized in determining said position of said at least one seismic source.

3. The method of claim 1 wherein the determined position of the at least one seismic source is compared with recorded position data from a previously conducted seismic survey.

4. The method of claim 3 wherein said position of the at least one seismic source is adjusted by means of a deflector attached to said seismic source array.

5. The method of claim 4 wherein a signal related to the comparison of the determined position of the at least one seismic source with a recorded position of a seismic source during a previously conducted seismic survey is transmitted to a deflector controller and said deflector controller alters a position of said deflector with respect to said seismic source array.

6. Apparatus for performing a repeated marine seismic survey comprising:
at least one seismic source being towed behind a seismic survey vessel during said repeated seismic survey;
means for determining the position of the at least one seismic source during said repeated marine seismic survey;
means for comparing the determined position of the at least one seismic source with a position of a seismic source during a previously conducted seismic survey; and
means for adjusting the position of the at least one seismic source in response to said comparison.

7. The apparatus of claim 1 wherein said means for determining the position of the at least one seismic source comprises a GPS receiver mounted on said at least one seismic source.

8. The apparatus of claim 1 further comprising data storage means in which position data from a previously conducted seismic survey is stored and a navigation system in which the determined position of the at least one seismic source is compared with said recorded position data from a previously conducted seismic survey.

9. The apparatus of claim 8 further comprising a deflector attached to said seismic source for adjusting said position of said at least one seismic source.

10. The apparatus of claim 9 further comprising a master controller which transmits a signal related to the comparison of the determined position of the at least one seismic source with a recorded position of a seismic source during a previously conducted seismic survey to a deflector actuator and said deflector actuator alters a position of said deflector.
